(19) United States
(12) Patent Application Publication
(10) Pub. No.: US 2025/0196218 A1
(43) Pub. Date: Jun. 19, 2025

(54) WORKING JIG, DIE SET USING THE WORKING JIG AND MANUFACTURING METHOD FOR WORKING JIG

(71) Applicant: NHK SPRING CO., LTD., Yokohama-shi (JP)

(72) Inventor: Yohei MITSUMORI, Yokohama-shi (JP)

(73) Assignee: NHK SPRING CO., LTD., Yokohama-shi (JP)

(21) Appl. No.: 18/968,995

(22) Filed: Dec. 4, 2024

(30) Foreign Application Priority Data
Dec. 14, 2023 (JP) 2023-210733

(51) Int. Cl. B21D 39/04

(52) U.S. Cl. CPC B21D 39/048

(57) ABSTRACT

According to an embodiment, a working jig has a body formed of metal having wear-resistance. A tapered surface is formed in an outer circumference of a distal end portion of the body. The tapered surface has a shape in which a diameter decreases toward an end face of the body. A center hole is formed in the body. Slits are formed at a plurality of positions in a circumferential direction of the body. The slits extend from the end face to positions in a length direction of the body in a direction along an axis. Chuck elements are formed between the slits which are adjacent to each other in the circumferential direction of the body. Punching portions are formed at distal ends of the chuck elements, respectively.

### CROSS-REFERENCE TO RELATED APPLICATIONS

This application is based upon and claims the benefit of priority from prior Japanese Patent Application No. 2023-210733, filed Dec. 14, 2023, the entire contents of which are incorporated herein by reference.

### BACKGROUND OF THE INVENTION

### 1. Field of the Invention

The present invention relates to a working jig used for the plastic working of a workpiece, a die set using the working jig, and a manufacturing method for a working jig.

### 2. Description of the Related Art

As an example of workpieces, a composite member consisting of a first component and a second component is known. To secure the first component and the second component to each other, plastic working called crimping, swaging, etc., is applied in some cases. For example, a local load is applied to part of the first component from the outside in a state where part of the second component is inserted into the first component. By plastically deforming part of the first component toward the second component in the radial direction by the load, they can be secured to each other. In this specification, the portion which is plastically worked in part of the workpiece may be called a target portion.

In an example of conventional devices, the target portion of a workpiece is plastically deformed by applying a load to a circumferential position of the workpiece from the outside in the radial direction. However, in this conventional device, the workpiece is awkwardly deformed, and thus, the outer appearance is degraded. In addition, as the target portion is one-sided at the circumferential position of the workpiece, the strength of the target position easily becomes unstable. In another conventional device, target portions are formed at two circumferential positions of a workpiece by applying a load from the both sides of the workpiece in the radial direction. However, there is a possibility that the central axis of the first component deviates from the central axis of the second component.

In yet another conventional device, diameter reduction processing is applied to a workpiece by a plurality of striking members provided in the circumferential direction of the workpiece. For example, the working device described in JP 2003-145233 A (Patent Literature 1) comprises an inner circular plate, an outer circular plate and a plurality of striking members. The outer circular plate is rotatably provided outside the inner circular plate. The striking members are provided at a plurality of positions in the circumferential direction of the inner circular plate. When the outer circular plate rotates, the striking members move toward the workpiece, and thus, the workpiece is plastically worked.

In the field of plastic working, in addition to Patent Literature 1, a rotary forging device called a rotary swaging machine is publicly known. An example of the rotary swaging machine is described in JP 2003-126938 A (Patent Literature 2). This rotary swaging machine comprises a plurality of striking members provided in the circumferential direction of the workpiece. The diameter of the workpiece can be reduced by striking the workpiece using the striking members in the radial direction from the outside.

By the working device described in Patent Literature 1 and the swaging machine described in Patent Literature 2, the whole circumference of a cylindrical metallic workpiece can be almost evenly plastically deformed. However, these conventional devices require very large facilities as a whole. In addition, since the grip of each workpiece (the portion to be gripped in each workpiece) is large, it is difficult to plastically deform part of a tiny workpiece (the target portion).

The present invention aims to provide a working jig, a die set and a manufacturing method for a working jig such that a plurality of circumferential positions of a workpiece can be plastically worked in the radial direction of the workpiece at the same time.

### BRIEF SUMMARY OF THE INVENTION

According to an embodiment, a working jig for plastically working a workpiece comprises a body. The body includes a center hole, a plurality of slits, a plurality of chuck elements, punching portions and an aperture into which the workpiece is inserted. The center hole is formed inside the body and extends in a direction along an axis of the body.

The slits are formed at a plurality of positions of the body and open on outer and inner surfaces of the body. These slits extend in a direction along the axis. The chuck elements are formed between the slits which are adjacent to each other. The punching portions are formed on the inner surfaces of the chuck elements facing the center hole, respectively. These punching portions project in directions facing each other. The aperture is formed on an end face of the body. This aperture is located on the axis. The number of punching portions corresponds to the number of the chuck elements.

The working jig of the embodiment may have a tapered surface. This tapered surface is formed on an outer surface of an end portion of the body and has a shape in which a width decreases toward the end face of the body.

The slits may be formed from the end face of the body to positions in a length direction of the body. Each of the chuck elements can be elastically deformed in a direction in which the punching portions approach each other. A circular hole for reducing the concentration of a stress may be formed at an end of each of the slits.

According to another embodiment, a die set comprising the working jig comprises a lower die which supports the working jig, a movable die and a pressure member. The movable die has a hole into which the body is inserted. A cam surface which is in contact with the body is formed in an inner circumference of the hole. The pressure member moves the movable die in a direction along the axis relative to the working jig.

The die set may comprise a workpiece supporting member inserted into the center hole of the working jig. A workpiece holding portion which holds the workpiece upright may be provided in the workpiece supporting member.

According to yet another embodiment, in a manufacturing method, the slits are formed in an intermediate product as a material of the working jig. The center hole is formed in the intermediate product by electro-discharge machining. A position of a distal end of the center hole is confirmed by an X-ray fluoroscope when the center hole is formed by the electro-discharge machining. The punching portions are processed into predetermined shapes. The end face of the body is processed such that a distance from the distal end of the center hole to the end face of the body becomes a predetermined value.

According to the working jig and die set of the embodiments, a plurality of positions of a workpiece can be plastically worked from the outside of the workpiece at the same time. In addition, a small workpiece can be plastically worked. According to the manufacturing method of the embodiment, a working jig formed of a solid metal material such as tool steel can be processed with high accuracy.

Additional objects and advantages of the invention will be set forth in the description which follows, and in part will be obvious from the description, or may be learned by practice of the invention. The objects and advantages of the invention may be realized and obtained by means of the instrumentalities and combinations particularly pointed out hereinafter.

### BRIEF DESCRIPTION OF THE SEVERAL VIEWS OF THE DRAWING

The accompanying drawings, which are incorporated in and constitute a part of the specification, illustrate embodiments of the invention, and together with the general description given above and the detailed description of the embodiments given below, serve to explain the principles of the invention.

FIG. 1 is a perspective view showing a working jig according to a first embodiment.

FIG. 2 is a front view showing the working jig shown in FIG. 1.

FIG. 3 is a plan view showing the working jig shown in FIG. 1.

FIG. 4 is a plan view in which the punch processing portion of the working jig shown in FIG. 3 is enlarged.

FIG. 5 is a side view showing part of a workpiece before the formation of a target portion.

FIG. 6 is a cross-sectional view showing the punch processing portion shown in FIG. 4 and the workpiece.

FIG. 7 is a cross-sectional view showing the punch processing portion shown in FIG. 4 and the workpiece in which the target portion is formed.

FIG. 8 is a side view showing part of the workpiece in which the target portion is formed.

FIG. 9 is a cross-sectional view showing a die set comprising the working jig shown in FIG. 1.

FIG. 10 is a perspective view showing the working jig of the die set shown in FIG. 9 and a movable die.

FIG. 11A is a front view showing an intermediate product of the working jig.

FIG. 11B is a front view showing the intermediate product in which a tapered surface is formed.

FIG. 11C is a front view showing the intermediate product in which a slit is formed.

FIG. 12A is a front view schematically showing an electric discharge machine, an X-ray fluoroscope and the intermediate product.

FIG. 12B is a front view schematically showing a working machine and the intermediate product.

FIG. 12C is a front view showing a complete working jig.

FIG. 13 is a perspective view showing a working jig according to a second embodiment.

### DETAILED DESCRIPTION OF THE INVENTION

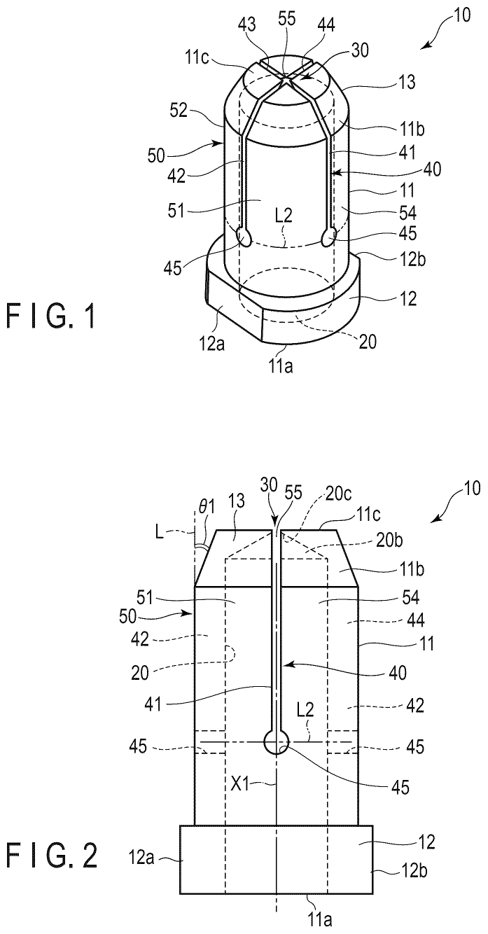

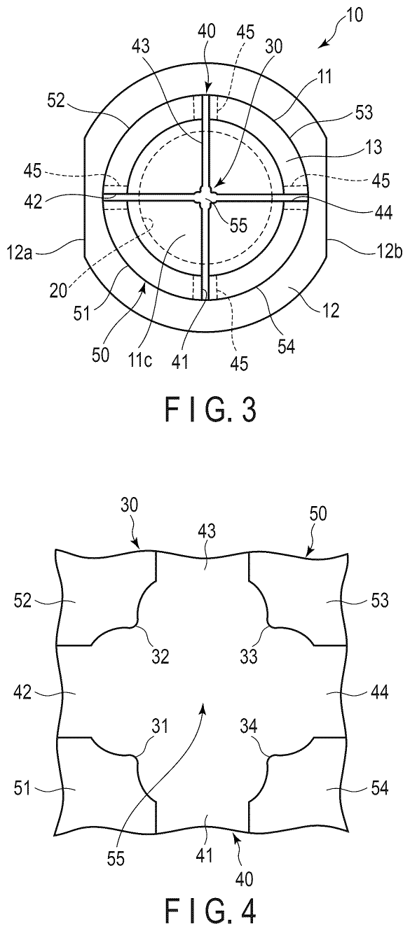

This specification explains a working jig 10 according to a first embodiment below with reference to FIG. 1 to FIG. 6. FIG. 1 is a perspective view showing the working jig 10. FIG. 2 is a front view showing the working jig 10. FIG. 3 is a plan view showing the working jig 10. FIG. 4 is a plan view in which part of the working jig 10 (punch processing portion) is enlarged.

The working jig 10 of the embodiment has a body 11, a flange portion 12 and a tapered surface 13. The flange portion 12 is formed in the base portion 11a of the body 11. The tapered surface 13 is formed in the outer circumference of the distal end portion 11b of the body 11. The body 11 of the embodiment has substantially a columnar shape. However, the body 11 may have a shape other than a columnar shape, such as a polygonal shape in which the section is rectangular. The distal end portion 11b of the body 11 of the embodiment includes the tapered surface 13. The distal end portion 11b of the body 11 has a shape close to a circular truncated cone. The diameter of the tapered surface 13 decreases toward an end face 11c of the body 11. When the body 11 is viewed laterally as shown in FIG. 2, the width of the tapered surface 13 decreases toward the end face 11c of the body 11. The tapered surface 13 forms a first angle θ1 with virtual line segment L1. Virtual line segment L1 extends in the length direction of the body 11 (in other words, a direction along axis X1).

The working jig 10 is integrally formed of a metal material such as steel. An example of the metal material is tool steel which is excellent in wear-resistance and toughness (for example, SKH51 high-speed steel). It should be noted that another steel type may be adopted. The chemical components (%) of the SKH51 high-speed steel are as follows: C: 0.80 to 0.88; Si: less than or equal to 0.45; Mn: less than or equal to 0.40; P: less than or equal to 0.030; S: less than or equal to 0.030; Cr: 3.80 to 4.50; Mo: 4.70 to 5.20; W: 5.90 to 6.70; V: 1.70 to 2.10; and Cu: less than or equal to 0.25.

As shown in FIG. 2, virtual axis X1 passing through the center of the body 11 extends in the length direction of the body 11. The end face 11c of the body 11 is a flat face which is perpendicular to axis X1. The tapered surface 13 is rotationally symmetrical with respect to axis X1. The diameter of the tapered surface 13 decreases toward the end face 11c of the body 11.

In this specification, a direction along axis X1 is referred to as the length direction of the body 11. A direction perpendicular to axis X1 is referred to as the radial direction of the body 11. The flange portion 12 projects in the radial direction of the body 11. A pair of flat surfaces 12a and 12b parallel to each other is formed in the flange portion 12.

A center hole 20 is formed inside the body 11. The center hole 20 extends in a direction along axis X1 of the body 11 from the base portion 11a of the body 11 toward the end face 11c. The center hole 20 includes a columnar inner surface 20a and a distal end side inner surface 20b which is substantially conical. The distal end side inner surface 20b is formed on the distal end side of the columnar inner surface 20a.

The columnar inner surface 20a is open in the base portion 11a of the body 11. The diameter of the columnar inner surface 20a is constant in a direction along axis X1. The distal end side inner surface 20b is formed on the inner side of the distal end portion 11b of the body 11. The distal end side inner surface 20b is open in the end face 11c of the body 11. A punch processing portion 30 (as shown in the enlarged view of FIG. 4) is formed in the distal end portion 11b of the body 11. The punch processing portion 30 includes, for example, four punching portions 31, 32, 33 and 34. The number of punching portions may be other than four.

At a plurality of (for example, four) circumferential positions of the body 11, slits 41, 42, 43 and 44 are formed. The slits 41, 42, 43 and 44 constitute a slit portion 40. Each of the slits 41, 42, 43 and 44 opens on the outer and inner surfaces of the body 11. The slits 41, 42, 43 and 44 extend in a direction along axis X1. Each of the slits 41, 42, 43 and 44 is formed from the end face 11c to position L2 in the length direction of the body 11 (as shown in FIG. 1 and FIG. 2). At position L2 in the length direction of the body 11, a circular hole 45 is formed. These circular holes 45 prevent the concentration of a stress on the ends of the slits 41, 42, 43 and 44. These holes 45 can reduce a stress generated in the body 11. The number of slits may be less than or equal to four or may be greater than or equal to four.

FIG. 3 shows a case where the number of slits is four. These slits 41, 42, 43 and 44 are formed at regular intervals at 90° for each slit in the circumferential direction of the body 11. A first chuck element 51 is formed between the first slit 41 and the second slit 42. A second chuck element 52 is formed between the second slit 42 and the third slit 43. A third chuck element 53 is formed between the third slit 43 and the fourth slit 44. A fourth chuck element 54 is formed between the fourth slit 44 and the first slit 41. These chuck elements 51, 52, 53 and 54 constitute a chuck portion 50. The number of chuck elements may be less than or equal to four or may be greater than or equal to four.

FIG. 4 is a plan view in which the punch processing portion 30 is enlarged. The projecting punching portions 31, 32, 33 and 34 are formed at the distal ends of the chuck elements 51, 52, 53 and 54, respectively. The punching portions 31, 32, 33 and 34 project to the inside of the body 11. An aperture 55 is formed between the punching portions 31, 32, 33 and 34 facing each other. A workpiece is inserted into the aperture 55. The aperture 55 is located on axis X1 of the body 11. Each of the punching portions 31, 32, 33 and 34 may be formed at a position other than the distal end portion 11b of the body 11. The punching portions 31, 32, 33 and 34 should be formed on the inner surfaces of the chuck elements 51, 52, 53 and 54 (the inner surfaces facing the center hole 20) at positions in a direction along axis X1. These punching portions 31, 32, 33 and 34 project in directions facing each other.

Each of the chuck elements 51, 52, 53 and 54 can elastically deform slightly in the radial direction of the body 11. FIG. 1 and FIG. 2 show the slit starting position L2 in the length direction of the body 11. In the chuck elements 51, 52, 53 and 54, the portions from the slit starting position L2 to the punching portions 31, 32, 33 and 34 can elastically deform. The chuck elements 51, 52, 53 and 54 can elastically deform in directions in which the punching portions 31, 32, 33 and 34 approach each other. In other words, the chuck elements 51, 52, 53 and 54 can elastically deform in the radial direction of the body 11 based on the slit starting position L2. When the chuck elements 51, 52, 53 and 54 elastically deform in the radial direction of the body 11, the size of the aperture 55 changes. The punching portions 31, 32, 33 and 34 face the aperture 55.

FIG. 5 shows part of a workpiece W before the formation of a target portion. For example, the workpiece W is a composite member which consists of a first component W1 and a second component W2. The first component W1 is made of metal and has a cylindrical shape. Part of the second component W2 in the length direction is inserted into the first component W1. A flange portion W3 for positioning is formed in the first component W1. A recess portion W4 may be formed in the second component W2.

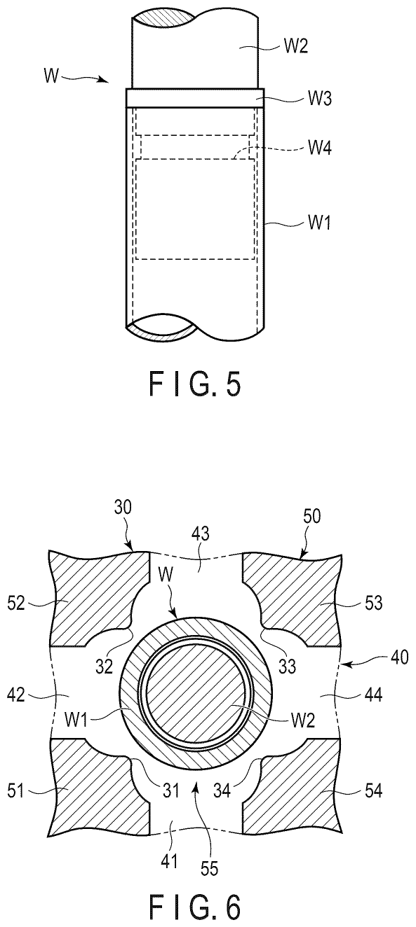

FIG. 6 is a cross-sectional view showing the punch processing portion 30 shown in FIG. 4 and the workpiece W before the formation of the target portion. The punch processing portion 30 shown in FIG. 6 is in a state where the aperture 55 expands (open position). The workpiece W is provided at the center of the aperture 55.

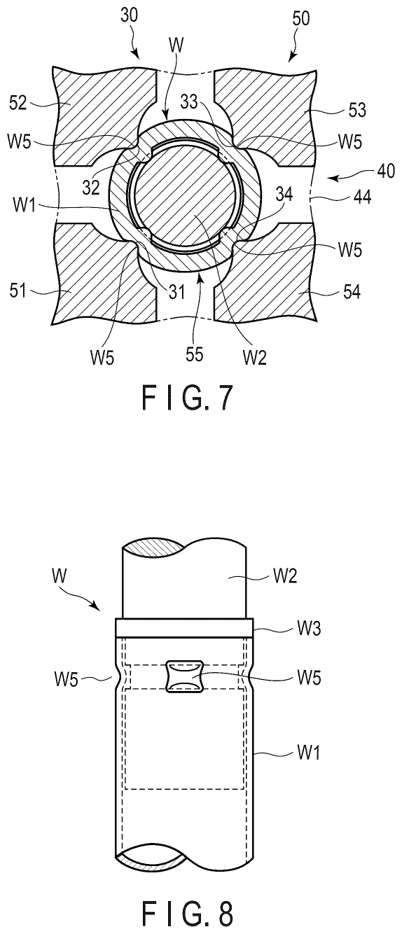

FIG. 7 shows a state where the punch processing portion 30 has moved in the closing direction. FIG. 8 is a side view showing part of the workpiece W in which the target portion W5 is formed. Part of the first component W1 is plastically deformed in the denting direction by applying pressure to part of the first component W1 by the punching portions 31, 32, 33 and 34. By this plastic deformation, the target portion W5 is formed. The first component W1 and the second component W2 are secured to each other by the target portion W5.

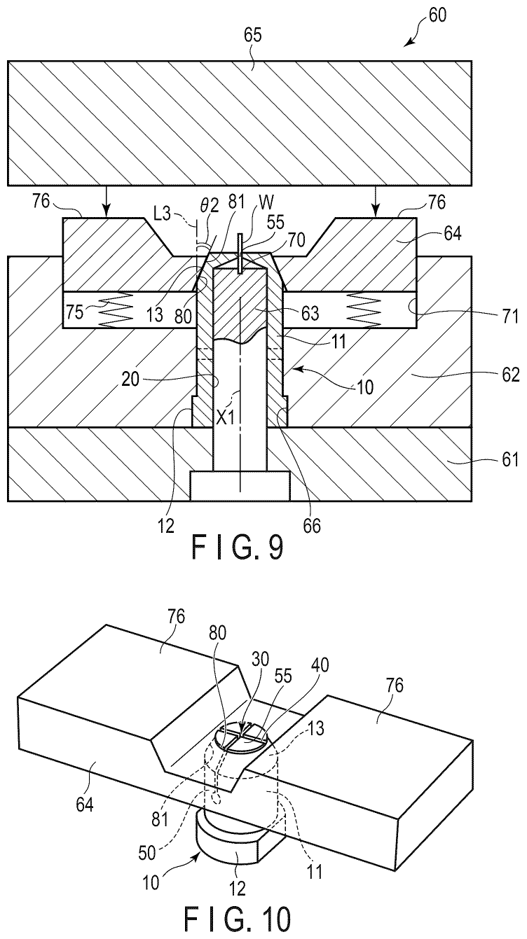

FIG. 9 shows a section of a die set 60 comprising the working jig 10. FIG. 10 is a perspective view showing part of the die set 60. As shown in FIG. 9, the die set 60 has a base member 61, a lower die 62, a workpiece supporting member 63, a movable die 64, a pressure member 65 and the like. The lower die 62 is placed in the base member 61. A recess portion 66 is formed in the lower die 62. The flange portion 12 engages with the recess portion 66. The working jig 10 is supported in a posture standing substantially perpendicularly by the lower die 62.

The workpiece supporting member 63 has a shape (columnar shape) which can be inserted into the center hole 20 of the working jig 10. The workpiece supporting member 63 is inserted into the center hole 20 of the body 11. A workpiece holding portion 70 is formed at the upper end of the workpiece supporting member 63. The workpiece holding portion 70 consists of, for example, a hole which extends in a direction along axis X1. The workpiece holding portion 70 is located on axis X1. The workpiece W is held on axis X1 in a posture standing perpendicularly by the workpiece holding portion 70. The workpiece W held by the workpiece supporting member 63 projects to the upper side from the aperture 55 of the punch processing portion 30.

The movable die 64 is provided in a guide portion 71 so as to be movable in a vertical direction. The guide portion 71 is formed in the lower die 62. The movable die 64 is biased to the upper side by a urging member 75 such as a spring. A load receiving portion 76 is formed in the movable die 64. The pressure member 65 moves the movable die 64 in a direction along axis X1.

As shown in FIG. 9 and FIG. 10, a hole 80 is formed in the movable die 64. A cam surface 81 is formed in the inner circumference of the hole 80. The distal end portion 11b of the body 11 is inserted into the hole 80 of the movable die 64. In a state where the distal end portion 11b is inserted into the hole 80, the tapered surface 13 of the working jig 10 is in contact with the cam surface 81. FIG. 9 shows virtual line segment L3 parallel to axis X1. The cam surface 81 forms a second angle θ2 with line segment L3. The second angle θ2 corresponds to the first angle θ1 of the tapered surface 13 (shown in FIG. 2).

FIG. 9 shows a state in which the movable die 64 and the pressure member 65 are located at ascending positions. At this time, the punch processing portion 30 of the working jig 10 is located at the open position shown in FIG. 6. The workpiece W held by the workpiece supporting member 63 is provided in the aperture 55 of the punch processing portion 30.

When the pressure member 65 is moved toward the lower side by a drive source, pressure is applied to the movable die 64 by the pressure member 65. Thus, the movable die 64 moves to the lower side. When the movable die 64 moves to the lower side, the cam surface 81 of the movable die moves to the lower side. The working jig 10 remains still. Therefore, when the cam surface 81 moves to the lower side along axis X1, the cam surface 81 presses the body 11 in the radial direction while sliding on the tapered surface 13. In this manner, the punching portions 31, 32, 33 and 34 move in a direction in which the aperture 55 shrinks.

As shown in FIG. 7, the punching portions 31, 32, 33 and 34 move in the closing direction. Since part of the first component W1 is pressed by the punching portions 31, 32, 33 and 34, plastic deformation occurs. In this manner, the target portion W5 is formed.

When the pressure member 65 moves to the upper side, the movable die 64 also moves to the upper side. When the movable die 64 moves to the upper side, the cam surface 81 moves to the upper side. Thus, the cam surface 81 relatively ascends with respect to the tapered surface 13. When the cam surface 81 relatively ascends, the punching portions 31, 32, 33 and 34 move in a direction in which the size of the aperture 55 is increased by the elastic restoring force of the chuck elements 51, 52, 53 and 54. Thus, the size of the aperture 55 is increased, and the punching portions 31, 32, 33 and 34 are separated from the workpiece W. In this manner, the workpiece W can be extracted from the aperture 55.

The die set 60 of the embodiment moves the movable die 64 in a direction along axis X1 with respect to the working jig 10. By moving the movable die 64, all of the chuck elements 51, 52, 53 and 54 can be moved in the radial direction of the body 11 by the cam surface 81 at the same time. Therefore, pressure can be applied to the workpiece W in the radial direction from the outside at the same time by the punching portions 31, 32, 33 and 34. Thus, a plurality of target portions W5 are formed at a plurality of positions in the circumferential direction of the workpiece W at regular intervals at the same time. In addition, the thickness of the punching portions 31, 32, 33 and 34 (thickness T2 shown in FIG. 12C) can be sufficiently reduced. Thus, small workpieces can be also plastically worked without problems.

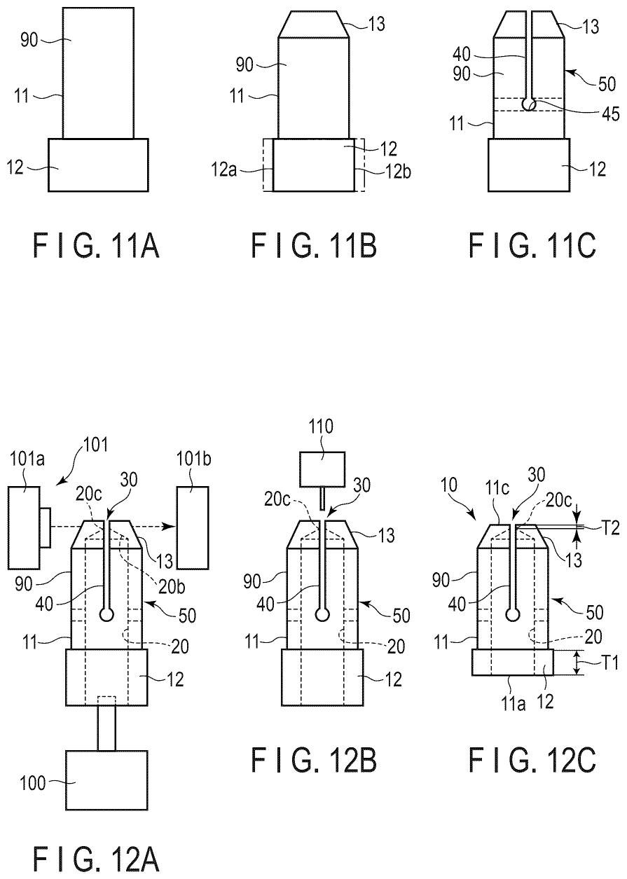

Now, this specification explains an example of the manufacturing method for the working jig 10 with reference to FIG. 11A to FIG. 11C and FIG. 12A to FIG. 12C.

FIG. 11A is a side view showing an intermediate product 90. The intermediate product 90 is the material of the working jig 10. Therefore, the product in the middle of the manufacturing of the working jig 10 is called the intermediate product 90. The intermediate product 90 shown in FIG. 11A has the solid body 11 and the flange portion 12.

As shown in FIG. 11B, the tapered surface 13 is formed in the distal end portion of the intermediate product 90 by, for example, machining. The flat surfaces 12a and 12b are formed in the flange portion 12.

As shown in FIG. 11C, the slit portion 40 is formed in the intermediate product 90 by, for example, machining or wire electro-discharge machining. Further, the circular hole 45 is formed at the end of the slit portion 40.

As shown in FIG. 12A, the center hole 20 is formed in the body 11 of the intermediate product 90. As an example of the means for forming the center hole 20, an electric discharge machine 100 and an X-ray fluoroscope 101 are used. The X-ray fluoroscope 101 comprises an X-ray source 101a and a detector 101b. By the electric discharge machine 100, the center hole 20 is formed from the base portion 11a of the body 11 to the distal end portion 11b.

At the time of electro-discharge machining, the X-ray fluoroscope 101 is used to confirm the distance from the distal end 20c of the center hole 20 to the end face 11c of the body 11. By the X-ray fluoroscope 101, the distance from the distal end 20c of the center hole 20 to the end face 11c of the body 11 is confirmed by X-ray examination. The electro-discharge machining of the center hole 20 is performed while confirming the distance from the distal end 20c to the end face 11c. Thus, the thickness of the punch processing portion 30 can be accurately controlled.

As shown in FIG. 12B, the punch processing portion 30 is processed by a processing machine 110. By this processing, the punching portions 31, 32, 33 and 34 having predetermined shapes (shown in FIG. 4 and the like) are formed. The processing machine 110 may correspond to machining or may correspond to other types of processing.

FIG. 12C shows thickness T1 of the flange portion 12. The base portion 11a of the body 11 is machined such that thickness T1 becomes a predetermined value. FIG. 12C shows distance T2 from the distal end 20c of the center hole 20 to the end face 11c of the body 11. The end face 11c is ground such that this distance T2 becomes a predetermined value. Distance T2 may be confirmed by using the X-ray fluoroscope 101 at the time of this grinding.

As stated above, the manufacturing method of the embodiment includes processes (1) to (5).

(1) The flange portion 12 and the tapered surface 13 are processed in the intermediate product 90 of the working jig.

(2) The slit portion 40 and the circular hole 45 are formed in the intermediate product 90.

(3) The center hole 20 is formed by electro-discharge machining. At this time, the position of the distal end 20c of the center hole 20 is confirmed by X-ray examination using the X-ray fluoroscope.

(4) The punch processing portion 30 is processed into a predetermined shape.

(5) The length of the intermediate product 90 is finished off so as to be a predetermined value by machining etc. In particular, the end face 11c is processed such that the distance from the distal end 20c of the center hole 20 to the end face 11c becomes a predetermined value.

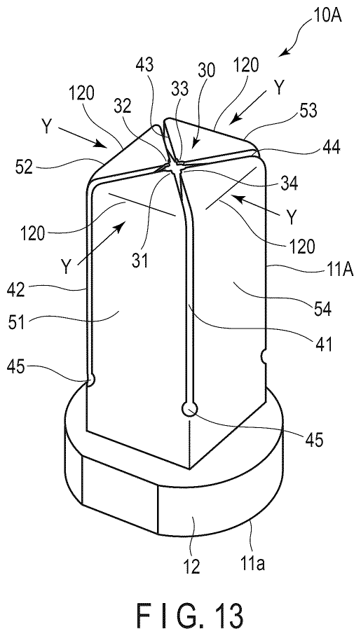

FIG. 13 is a perspective view showing a working jig 10A according to a second embodiment. The working jig 10A has a body 11A having substantially a quadrangular prism shape. In a manner similar to that of the first embodiment, a plurality of slits 41, 42, 43 and 44 are formed in the body 11A. The body 11A does not have the tapered surface 13 of the first embodiment (shown in FIG. 1, FIG. 2 and the like). Since the other structures are common to the first embodiment and the second embodiment, common reference numbers are added to the common portions of the first and second embodiments, thereby omitting explanations thereof.

The distal end portion 120 of each of chuck elements 51, 52, 53 and 54 shown in FIG. 13 is brought into contact with the cam surface of a die set (for example, the cam surface 81 shown in FIG. 9). By this cam surface, the chuck elements 51, 52, 53 and 54 are driven in the directions indicated by arrows Y in FIG. 13. In this manner, punching portions 31, 32, 33 and 34 can be moved in the closing direction. As the punching portions 31, 32, 33 and 34 are moved in the closing direction, a workpiece can be plastically worked. It should be noted that the body 11A may have a shape other than a quadrangular prism, such as a polygonal shape in which the section is a hexagon, an octagon or the like. A tapered surface having an angle corresponding to the cam surface 81 may be formed in the outer surface of the end portion of the body 11A.

When the present invention is implemented, the elements constituting the die set can be changed depending on the need regarding the shapes, structures and the like of the working jig. The number of slits and the number of punching portions formed in the body may be other than four. Moreover, each workpiece is not limited to a composite member consisting of a plurality of components and may be a workpiece consisting of only one component.

Additional advantages and modifications will readily occur to those skilled in the art. Therefore, the invention in its broader aspects is not limited to the specific details and representative embodiments shown and described herein. Accordingly, various modifications may be made without departing from the spirit or scope of the general inventive concept as defined by the appended claims and their equivalents.

What is claimed is:

1. A working jig used for plastic working of a workpiece, the working jig comprising:
a body;
a center hole formed inside the body and extending in a direction along an axis of the body;
a plurality of slits formed at a plurality of positions of the body, opening on outer and inner surfaces of the body, and extending in a direction along the axis;
a plurality of chuck elements formed between the slits which are adjacent to each other in the body;
punching portions formed on the inner surfaces of the chuck elements facing the center hole, and projecting in directions facing each other; and
an aperture into which the workpiece is inserted.

2. The working jig of claim 1, having a tapered surface which is formed on an outer surface of an end portion of the body and in which a width decreases toward an end face of the body.

3. The working jig of claim 1, wherein
the slits are formed from the end face of the body to positions in a length direction of the body, and
each of the chuck elements can be elastically deformed in a direction in which the punching portions approach each other.

4. A die set comprising the working jig of claim 1, the die set comprising:
a lower die which supports the working jig;
a movable die having a hole into which the body is inserted, and having a cam surface which is in contact with the body in an inner circumference of the hole; and
a pressure member which moves the movable die in a direction along the axis relative to the working jig.

5. The die set of claim 4, further comprising
a workpiece supporting member inserted into the center hole of the working jig, and comprising a workpiece holding portion which holds the workpiece.

6. A manufacturing method for manufacturing the working jig of claim 1, the method comprising:
forming the slits in an intermediate product as a material of the working jig;
forming the center hole in the intermediate product by electro-discharge machining;
confirming a position of a distal end of the center hole using an X-ray fluoroscope by X-ray examination when the center hole is formed by the electro-discharge machining;
processing the punching portions into predetermined shapes; and
processing the end face such that a distance from the distal end of the center hole to the end face of the body becomes a predetermined value.
